(19) United States
(12) Patent Application Publication
(10) Pub. No.: US 2024/0162931 A1
(43) Pub. Date: May 16, 2024

(54) Protective case for a mobile electronic device and mobile system

(71) Applicant: Natalja Rempel, Osnabrueck (DE)

(72) Inventor: Natalja Rempel, Osnabrueck (DE)

(21) Appl. No.: 18/518,650

(22) Filed: Nov. 24, 2023

(30) Foreign Application Priority Data
Sep. 14, 2022 (DE) 10 2023 003 718.4

(51) Int. Cl. H04B 1/3888; G06F 1/16

(52) U.S. Cl. CPC H04B 1/3888; G06F 1/1656

(57) ABSTRACT

Protective case (30) for a mobile electronic device (20) having a touch-sensitive display device (21), comprising, a rear wall cover (31), a side wall cover (32), the side wall cover (32) having at least one peripheral edge (33) formed on an upper side of the protective case (30), which is provided for circumferential engagement and/or abutment against the display device (21) of the mobile device (20), and a receiving opening (34), by means of which the mobile device (20) can be inserted and/or introduced into the interior of the protective sheath (30). The edge (33) has at least one first and at least one second edge section (330-331B), the second edge section (331A, 331 B) being designed in the manner of a wiping and/or gesture edge for wiping over and/or swiping over with a finger (F) and being lowered with respect to the first edge section (330).

### REFERENCE TO RELATED APPLICATIONS

This application claims priority to, and the benefit of German Application DE 10 2023 003 718.4, filed on Sep. 14, 2023, the contents of which are hereby incorporated by reference.

### DESCRIPTION

The invention relates to a protective case for a mobile electronic device according to the preamble of claim 1 and an mobile system according to the preamble of claim 7.

A wide range of different mobile electronic devices are used in both business and private environments. In addition to the widespread cell phones or smartphones, these also include tablets, smartwatches, eBook readers, audio players and so on. Modern mobile devices typically have at least one touch-sensitive display device, in particular a touchscreen, by means of which the mobile device can be operated, in particular by touching it with one or more fingers of an operator. Different functions of the mobile device can be triggered by a wipe operation or a gesture with the one or more fingers.

Generic mobile devices are relatively sensitive and cost-intensive to build, which is why the use of so-called protective cases for such mobile electronic mobile devices has become established in order to protect such mobile devices, for example, in the event of an accidental drop to the ground and/or to at least soften impacts. Such protective cases are described, for example, in the printed publications US 2016/0249472 A1 and US 2017/0359096 A1. Accordingly, protective cases for mobile electronic devices, in particular smartphones, having a touch-sensitive display device, in particular a touch screen, are known, which have, inter alia, at least one rear panel cover for at least partially covering and/or enveloping a rear side of the device. Furthermore, such protective cases comprise at least one side wall cover for at least sectionally covering and/or enveloping a side wall, in particular a lateral periphery, of the mobile device. The at least one side wall cover further comprises at least one circumferential edge formed on an upper side of the protective case, in particular of the side wall cover, which edge is provided for circumferentially engaging around and/or abutting against the display device of the mobile device. Furthermore, such a protective case has at least one receiving opening, in particular surrounded and/or enclosed at least in sections by the edge, by means of which the mobile device can be inserted and/or introduced into the interior of the protective case. In other words, the mobile device is at least substantially enclosed and/or protected by means of such a protective case, wherein the display device, in particular the touch screen, is still at least largely accessible and/or operable for operation with the one or more fingers.

However, protective cases designed in this way have proved to be rather disadvantageous when used on mobile devices which have a relatively particularly large display device and/or a display device with at least virtually no edge on the circumference, in particular relative to the housing of the device. This is because the display edge is at least largely or completely covered by the edge for protecting the display device and/or for fastening the protective case to the mobile device and/or is inaccessible for operation with the one or more fingers. This also has the disadvantage that functions which can actually be triggered by wiping over and/or gestures over the display edge cannot be called up or can only be used in an impaired manner. Furthermore, manufacturers of such devices cannot implement additional functions that can be accessed via the display edge, or can only do so to a limited extent, taking previous protective cases into account.

The task underlying the invention is thus to design a protective case for a mobile electronic device in such a way that, when such protective cases are used, the accessibility and/or operability of the device, in particular of the display device, is improved with at least virtually unimpaired protection.

This task is solved according to the invention in that the edge, in particular of the protective case, has at least one first and at least one second edge section, the second edge section being designed in the manner of a wiping and/or gesture edge for wiping over and/or swiping over with a finger and being lowered relative to the first edge section.

As a result of this measure, protective case is created by means of which, on the one hand, a mobile device, in particular the display device and/or the display edge, can be enclosed and/or covered by the protective case at least to the greatest possible extent on the circumferential side, and, on the other hand, the mobile device, in particular the display device and/or the display edge, can be operated with one or more fingers at least virtually without impairment. In particular, it is provided that the display device and/or the display edge, starting from the second edge section, can be swept over at least almost seamlessly with the one or more fingers.

According to the invention, wiping and/or swiping over the second edge section and/or the display device is preferably to be understood as a wiping and/or swiping movement with one or more fingers. In other words, the one or more fingers are drawn over the second edge section and/or the display device in a touching manner for this purpose. Alternatively or additionally, wiping and/or swiping may be understood to mean performing a touch gesture. Thus, a wipe and/or gesture edge preferably defines at least a section of the second edge section which is swept together with the display device in a wipe and/or swipe operation with the finger. Alternatively or additionally, the wipe and/or gesture edge may also be referred to as a wipe and/or gesture contour.

The second edge section is preferably formed on the side wall cover. Furthermore, the side wall cover is preferably formed in the manner of a protective case and/or is provided for lateral protection of the mobile device, in particular of the housing side walls. Alternatively or additionally, the second edge section can be connected to the side wall cover and/or to the back wall cover in a form-fitting and/or material-fitting manner. Equally preferably, the second edge section and the back wall cover may be connected to each other via the side wall cover. The side wall cover is further preferably formed at least substantially perpendicular to the back wall cover and/or formed perpendicular to the back wall cover.

Furthermore, the protective case according to the invention is preferably formed in one piece. A protective case consisting of a flexible material, such as plastic, rubber, silicone, TPU or the like, is particularly preferred. It is further preferred if the protective case can be at least partially pulled over the mobile device.

In a preferred embodiment of the protective case according to the invention, the second edge section has a lower and/or sloping edge height compared to the first edge section. Thus, when viewed from the display device and/or the back wall cover, the edge height of the second edge section is less than the edge height of the first edge section. In other words, the second edge section is arranged closer to the display device and/or the display edge than the first edge section when the mobile device is inserted. This has the advantage that a relatively particularly small transition (between the protective case and the mobile device) has to be overcome with the finger in order to perform a wiping and/or swiping gesture on the display device and/or the display edge.

In a further embodiment of the protective case according to the invention, a second edge height associated with the second edge section is formed to be smaller by at least 0.25 mm, preferably by at least 0.5 mm or more, than a first edge height associated with the first edge section. Such an embodiment has the advantage that on the one hand a small transition is created between the protective case and the mobile device, in particular the display device and/or the display edge, and on the other hand the mobile device, in particular the display device and/or the display edge, continues to be protected by the protective case, in particular the second edge section.

In another preferred embodiment of the protective case according to the invention, the second edge section has a contour that slopes downward toward the interior and/or toward the receiving opening. In other words, the edge height of the second edge section can be designed to slope downwards from the outer circumference towards the interior of the protective case and/or towards the display device, in particular the display edge. Thus, the second edge section is formed at least in sections in the manner of a ramp with a slope descending towards the interior of the protective envelope and/or towards the display device. With such an embodiment, protective case is created which has a maximum protection of the mobile device with an improved accessibility of the display device, in particular of the display edge, for the finger of an operator.

In another further embodiment of the protective case according to the invention, the second edge section has a different surface texture compared to the first edge section, preferably with less roughness and/or a different feel. The second edge section may in this case preferably be formed from a different material than the first edge section and/or be coated. Alternatively or additionally, the second edge section may here have one or more recesses, recesses and/or projections which influence the roughness and/or feel of the second edge section. A roughness that is lower than that of the first edge section is particularly advantageous for carrying out wiping and/or stroking movements with the finger over the second edge section. A different haptic can be advantageous in particular for haptic differentiation between the different edge sections, so that the mobile device, in particular the display device, can also be operated without a visual control view and thus more quickly.

In a further preferred embodiment of the protective case according to the invention, the second edge section is positioned along the edge in such a way that the display device of the mobile device, in particular smartphone, can be actuated with a finger by wiping and/or sweeping over the second edge section, in particular in a direction towards the interior of the protective case and/or the receiving opening. Furthermore, the second edge section can be formed in such a way that one or more fingers are guided at least in sections along the second edge section towards the interior of the protective case and/or the receiving opening.

According to the invention, protective case for a mobile device is thus preferred which has different edge heights along the edge running around the display device and/or the display edge of the device.

The task underlying the invention is further solved by a mobile system comprising a mobile electronic device, preferably a smartphone, with a touch-sensitive display device, in particular a touch screen, and protective case for the device, wherein the protective case is designed according to at least one of the embodiments described above. With regard to the advantages and modifications of the mobile system according to the invention, reference is first made to the advantages and modifications of the protective case according to the invention.

The mobile system comprises a mobile electronic device with a touch-sensitive display device, in particular a touchscreen. The mobile device is preferably designed in the manner of a smartphone, a tablet, a smartwatch, an eBook reader or audio player or another electronic device with a touchscreen. Furthermore, the mobile system comprises protective case, preferably in accordance with the preceding type, which has at least one rear wall cover for covering and/or enclosing a rear side of the mobile device at least in sections. Likewise, the protective case here has at least one side wall cover for at least sectionally covering and/or enveloping a side wall, in particular a lateral periphery, of the mobile device. The side wall cover further comprises at least one circumferential edge formed on an upper side of the protective case, in particular of the side wall cover, which edge is provided for circumferentially engaging around and/or resting against the display device of the mobile device. Furthermore, the protective case here comprises a receiving opening, in particular surrounded and/or enclosed at least in sections by the edge, by means of which the mobile device can be inserted and/or introduced into the interior of the protective case and/or through which the display device of the mobile device is released for actuation with one or more fingers.

In a further development of the mobile system according to the invention, the second edge section, in particular the second edge height, is lowered and/or formed relative to the first edge section in such a way that the mobile device, in particular the display device, is surrounded and/or enclosed, in particular protected, on the circumferential side by the second edge section.

Furthermore, a mobile system according to the invention is preferred in which a transition formed between the mobile device, in particular the display device, and the second edge section is designed to be at least virtually stepless. Alternatively or additionally, the transition between the second edge section and the mobile device, in particular the display device, can be designed in such a way and/or have such a small step that it cannot be perceived, in particular haptically, by the operator, or can at least hardly be perceived by the operator.

In another preferred embodiment of the mobile system according to the invention, the protective case has a plurality of second edge sections, preferably positioned at different positions along the edge, it being provided that different functions of the mobile device can be triggered or executed by wiping over and/or swiping over the respective second edge sections. Thus, at least one of the second edge sections can be provided for triggering or executing a first device function and at least one other second edge section can be provided for triggering or executing a second device function.

It is further preferred that the plurality of second edge sections have a different surface texture relative to each other, so that the different second edge sections are particularly preferably distinguishable by the operator in a haptic manner.

According to the invention, a mobile system with a device and protective case is thus preferred, in which the protective case has different edge heights along the edge running around the display device and/or the display edge of the device.

Further details of the invention can be found in the example description and drawings. The drawings show

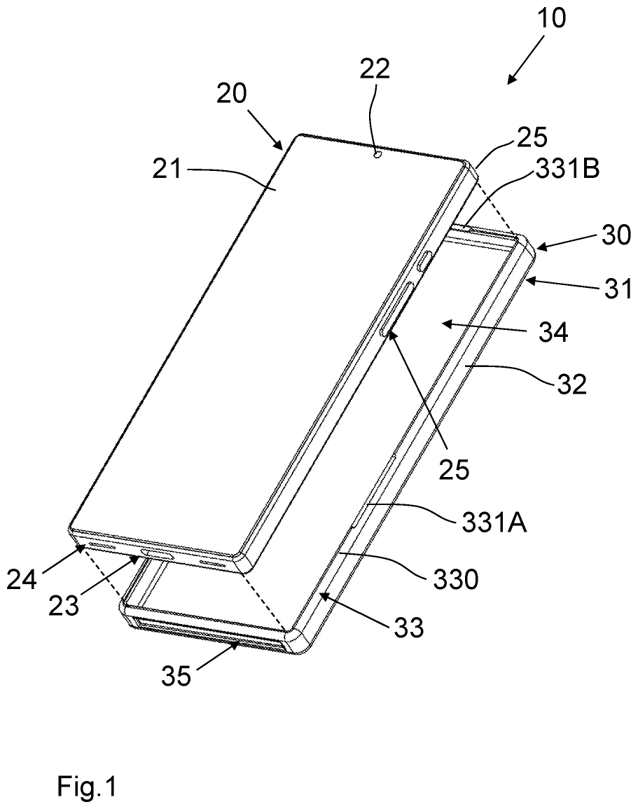

FIG. 1 a first embodiment of a mobile system with a protective case according to the invention and a mobile electronic device in a perspective exploded view;

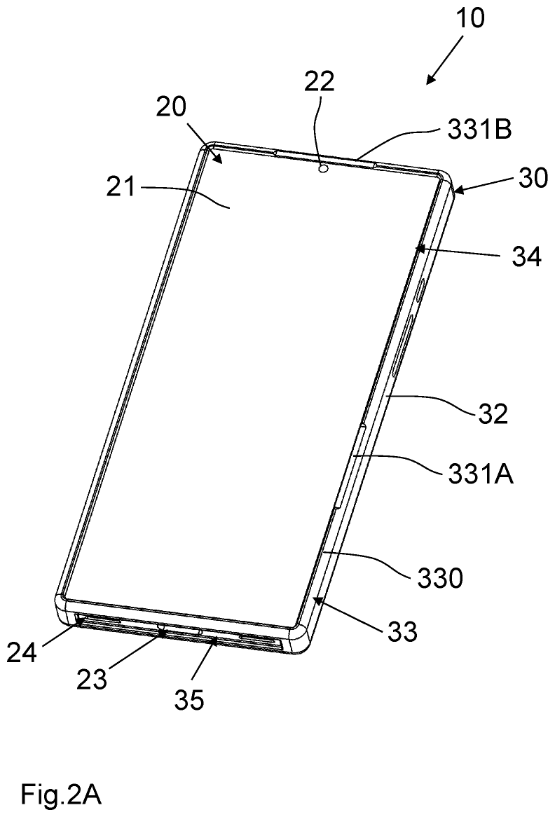

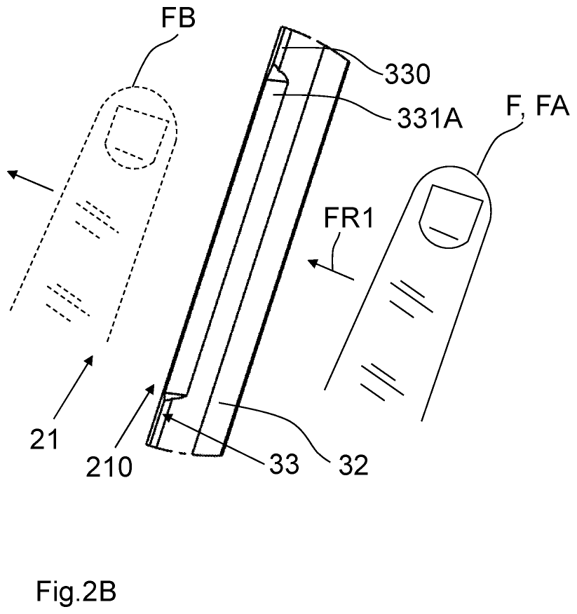

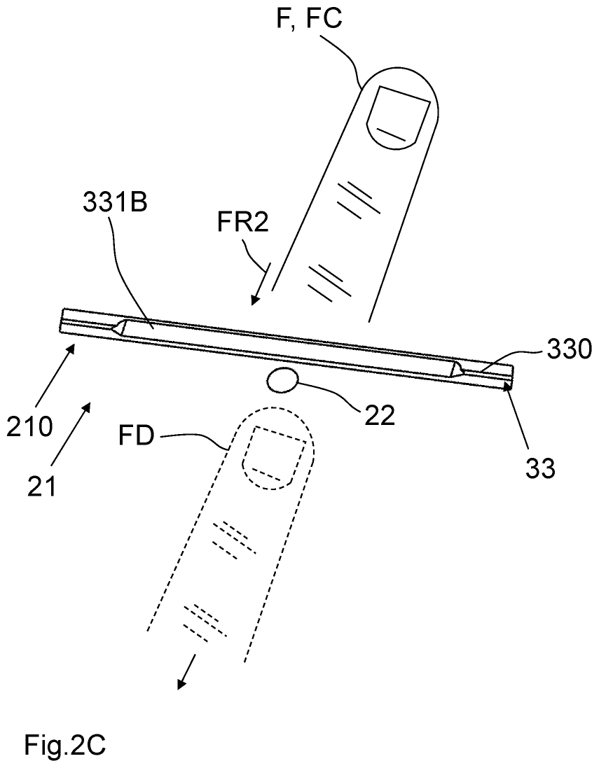

FIG. 2A the mobile system from FIG. 1 with the device placed in the protective case in a perspective view;

FIG. 2B an enlarged view of the second edge section according to the invention;

FIG. 2C an enlarged view of another second edge section according to the invention;

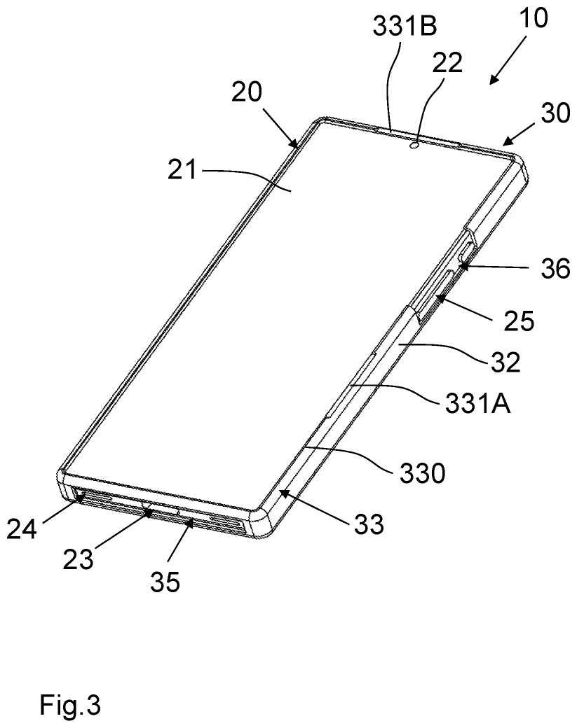

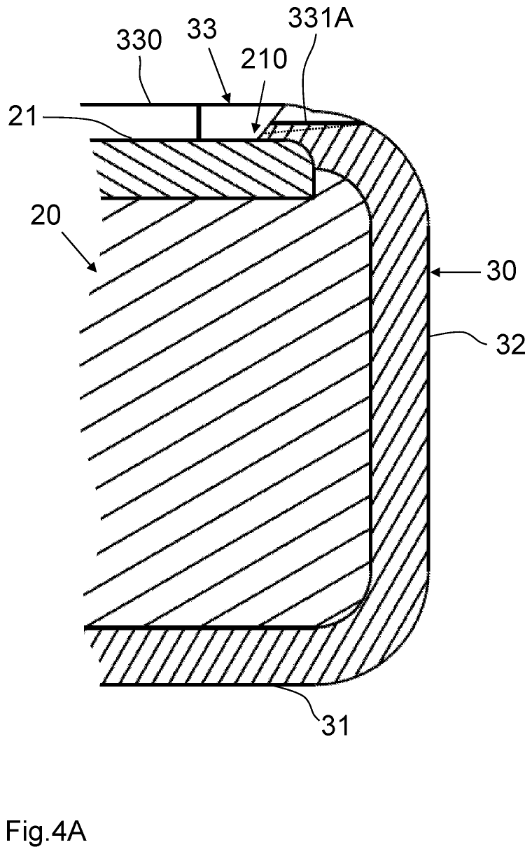

FIG. 3 a second embodiment example of a mobile system with a protective case according to the invention and a mobile electronic device in a perspective view;

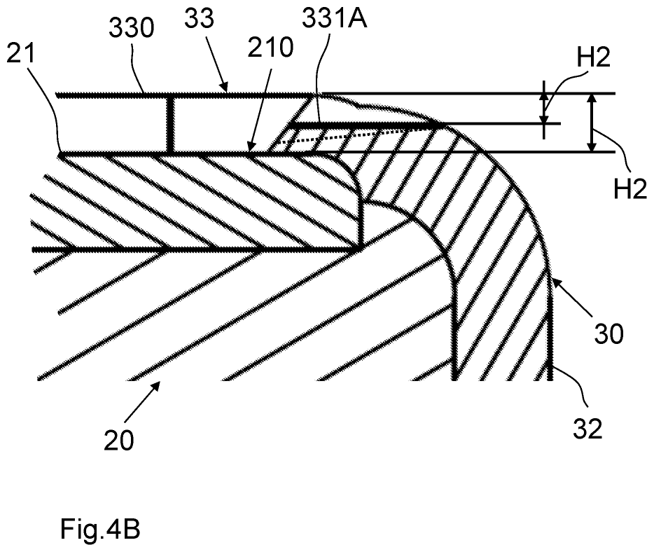

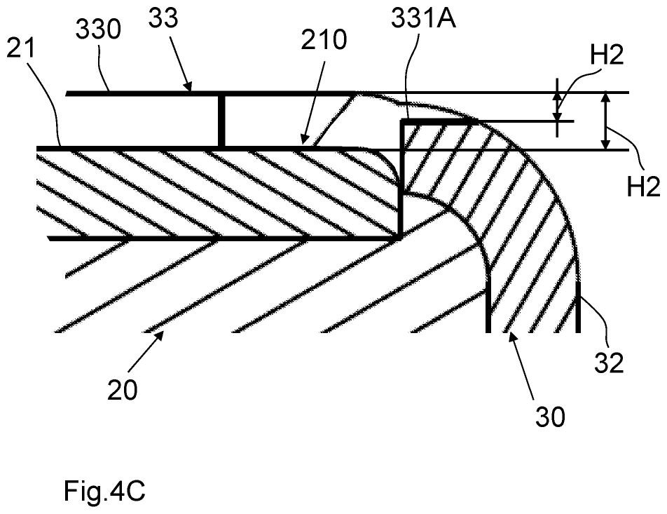

FIG. 4A the mobile system in full section and in enlarged view from below;

FIG. 4B the mobile system of FIG. 4A with the second edge section according to the invention in a detailed view; and

FIG. 4C a second embodiment example of the second edge section according to the invention in a detailed view.

In the following description, the same reference signs are used for the same objects.

In FIG. 1, a mobile system 10 with a mobile electronic device 20 and a protective case 30 according to the invention is shown in an exploded view. The mobile device 20 can be seen in a state dismantled from the protective case 30 or not wrapped in it. Here it can be seen that the mobile device 20 is designed as a mobile telephone or smartphone and is equipped with a touch-sensitive display device 21, in particular a touch screen. Alternatively and/or additionally, the mobile mobile device 20 can also be designed as a tablet, smartwatch, eBook reader, audio player or the like.

In addition to the display device 21, the mobile device 20 optionally comprises a detection device 22, in particular a camera, a charger port 23, one or more speakers 24, a microphone and/or control buttons 25, e.g. for volume control of the speakers 24 and/or for switching the mobile device 20 on or off.

Furthermore, the mobile device 20, in particular the housing of the mobile device 20, also has side walls 25 arranged laterally or circumferentially in addition to a rear side or rear wall not shown in the figures. The side walls 25 are formed here in the manner of a circumferential frame.

The protective case 30 also shown in FIG. 1 has, among other things, a rear wall cover 31 which, in particular in the case of the inserted mobile device 20, is provided for covering and/or enclosing a rear side of the mobile device 20 at least in sections. Furthermore, the protective case 30 comprises a side wall cover 32, in particular surrounding and/or formed on the back wall cover 31. The side wall cover 32 is provided for at least sectionally covering and/or enveloping the side wall 25, in particular the lateral periphery or frame, of the mobile device 20. At least one peripheral edge 33 arranged on an upper side of the protective case 30, in particular of the side wall cover 32, is formed on and/or along the side wall cover 32, which edge 33 is provided for circumferentially engaging around and/or resting against the display device 21 of the mobile device 20. The protective case 30 further comprises a receiving opening 34, in particular surrounded and/or enclosed at least in sections by the edge 33, by means of which the mobile device 20 can be inserted and/or introduced into the interior of the protective case 30.

In addition, the protective case 30 optionally has at least one cutout 35, arranged here by way of example on the underside, by means of which the charger connection 23, which is also optional here, and/or the one or more optional speakers 24 are exposed and/or accessible even when the mobile device 20 is inserted.

In FIG. 2A, the mobile device 20 is shown inserted in the protective case 30. As can be clearly seen here, the protective case 30 is precisely adapted to the mobile device 20. In this case, the protective case 30 is formed in one piece and from a flexible material, in particular silicone. Alternatively and/or in addition thereto, the protective case 30 can also be multi-part and/or formed from another material, such as plastic, elastomer (rubber), TPU or the like.

According to the invention, the edge 33 has at least one first edge section 330 and at least one second edge section 331A, 331B. In the embodiment shown, a plurality of, in particular two, second edge sections 331A, 331B are formed along the edge 33, although the protective case 30 may alternatively comprise only a single second edge section 331A, 331B. The second edge sections 331A, 331B are each formed in the manner of a wiping and/or gesturing edge or contours for wiping and/or swiping over with a finger and are lowered relative to the first edge section 330.

The second edge sections 331A, 331B are positioned along the edge 33 such that the display device 21 of the mobile device 20, in particular smartphone, can be actuated by wiping and/or swiping over the second edge sections 331A, 331B with a finger.

In FIG. 2B, the, in particular lateral or right, second edge section 331A is shown in enlarged view. Here, a finger F of an operator of the mobile device 20 can also be seen. The finger F is initially located at the position FA to the right of the protective case 30 and/or the mobile device 20. To trigger and/or execute a defined function of the mobile device 20, the finger F is guided from the position FA over the second edge section 331A in the wiping and/or swiping direction FR1 to the position FB and thus onto the display device 21, in particular a display edge 210.

In FIG. 2C, the other second edge section 331B, in particular arranged at the upper edge 33, is shown in enlarged view. Here, a finger F of the operator is likewise shown for illustration purposes. The finger F is initially located at the position FC above the protective case 30 and/or the mobile device 20. To trigger and/or execute a defined, in particular different, function of the mobile device 20, the finger F is guided from the position FC over the other second edge section 331B in the wiping and/or swiping direction FR2 to the position FD and thus onto the display device 21, in particular a display edge 210.

By means of such wiping and/or swiping gestures performed via the second edge section 331A, 331B, functions implemented on the mobile device 20 can be triggered which can only be triggered via the display edge 210. In particular, it can be provided that different functions of the mobile device 20 can be triggered or executed on the basis of the different second edge sections 331A, 331B shown here.

For the sake of completeness, FIG. 3 shows a second embodiment of the mobile system, in particular of the protective case 30 according to the invention. Here, the protective case 30 has a further cutout 36, in particular a control panel cutout, on the upper half of the right-hand side of the protective case 30, by means of which the control keys 25 of the inserted mobile device 20 are released. In this case, the cutout 36 extends over the edge 33, in particular the first edge section 330, and partially over the side wall cover 32. With such a cutout 36, the display edge 210 is released for operation by means of wiping and/or swiping gestures, but is not protected from impacts or other external influences.

For simplicity and brevity, FIG. 4A and FIG. 4B are described together below.

In FIGS. 4A and 4B, enlarged views of the mobile system are shown in a sectional view (full section), on the basis of which further details of the, here right, second edge section 331A can be seen. Here it can be seen well that the display device 21, in particular the display edge 210, is circumferentially and in a protective manner embraced and/or enclosed by the second edge section 331A. The second edge section 331A further has a lower and/or sloping edge height compared to the first edge section 330. As can be seen particularly well from FIG. 4B, a second edge height H2 associated with the second edge section 331A is formed to be smaller than a first edge height H1 associated with the first edge section 330. In particular, it is provided that the second edge height H2 is formed smaller than the first edge height H1 by at least about 0.25 to 0.5 mm. Alternatively or additionally, the second edge height H2 can also be at least up to 1 mm or 2 mm smaller than the first edge height H1. The edge heights H1, H2 are dimensioned here by way of example starting from the display device 21, although any other dimensioning points on the protective case 30 and/or on the mobile device 20 would also be conceivable as an alternative.

Alternatively or additionally, the contour of the second edge section 331A can also be formed according to the indicated dotted line, which indicates a second edge section 331A with a contour sloping towards the interior and/or towards the receiving opening 34. In particular, it is provided that a transition formed between the mobile device 20, in particular the display device 21, and the second edge section 331A is formed at least almost steplessly and/or haptically at least hardly perceptible.

Furthermore, the second edge section 331A can also be formed according to the further embodiment example shown in FIG. 4C. Here, the second edge section 331A is formed to abut the display device 21, in particular the display edge 210, in a protective manner.

As cannot be seen from the figures, but can be provided according to the invention, the second edge section 331A can have a different surface texture compared to the first edge section 330. In particular, it may be provided that the second edge section 331A has a lower roughness and/or different feel compared to the first edge section 330. Furthermore, it may also be provided in the case of a plurality of second edge sections 331A, 331B that the surface texture differs between the second edge sections 331A, 331B.

It is understood that features mentioned in the previously described embodiment examples are not limited to these particular combinations and are also possible in any other combinations. Furthermore, it is understood that geometries shown in the figures are only exemplary and are also possible in any other embodiments.

### LIST OF REFERENCE CHARACTERS

10 Mobile system
20 Mobile electronic device
21 Display device
210 Display edge
22 Detection device
23 Charger connection
24 Speaker
25 Side wall
30 Protective case
31 Back cover
32 Side wall cover
33 Edge
330 First edge section
331A, 331B Second edge section
34 Receiving opening
35 Cutout
36 Cutout
F Finger
FA-FD Finger positions
FR1, FR2 Wiping and/or swiping direction
H1 First edge height
H2 Second edge height

1. Protective case for a mobile electronic device, preferably smartphone, with a touch-sensitive display device, in particular a touch screen; comprising;
a back cover for at least partially covering and/or enclosing a rear side of the mobile device;
a side wall cover for at least partially covering and/or enveloping a side wall, in particular a lateral periphery, of the mobile device, the side wall cover having at least one peripheral edge which is formed on an upper side of the protective case, in particular of the side wall cover, and which is provided for circumferentially engaging around and/or abutting against the display device of the mobile device; and
a receiving opening, in particular surrounded and/or enclosed at least in sections by the edge, by means of which the mobile device can be inserted and/or introduced into the interior of the protective case;
characterized in that the edge has at least one first and at least one second edge section, the second edge section being formed in the manner of a wiping and/or gesture edge for wiping over and/or swiping over with a finger and being lowered relative to the first edge section.

2. Protective case according to claim 1, characterized in that the second edge section has a lower and/or sloping edge height compared to the first edge section.

3. Protective case according to claim 2, characterized in that a second edge height associated with the second edge section is formed smaller by at least 0.25 mm, preferably by at least 0.5 mm or more, compared to a first edge height associated with the first edge section.

4. Protective case according to claim 1, characterized in that the second edge section has a contour sloping towards the interior and/or towards the receiving opening.

5. Protective case according to claim 1, characterized in that the second edge section has a different surface texture compared to the first edge section preferably with lower roughness and/or different haptics.

6. Protective case according to claim 1, characterized in that the second edge section is positioned along the edge in such a way that the display device of the mobile device, in particular smartphone, can be actuated by wiping and/or sweeping over the second edge section with a finger.

7. Mobile system, comprising;
a mobile electronic device, preferably a smartphone, with a touch-sensitive display device, in particular a touch screen; and
a protective case, preferably in accordance with the preamble of the preceding claims, having at least one rear wall cover for at least partially covering and/or enclosing a rear side of the mobile device, at least one side wall cover for at least partially covering and/or enclosing a side wall, in particular a lateral periphery, of the mobile device, the side wall cover having at least one edge which runs around and is formed on an upper side of the protective case, in particular of the side wall cover, and which is provided for engaging around and/or abutting against the display device of the mobile device on the peripheral side, and an edge, in particular of the side wall cover, which is provided for engaging around and/or abutting against the display device on the peripheral side, in particular the side wall cover, which is provided for circumferential engagement and/or abutment against the display device of the mobile device, and a receiving opening, in particular surrounded and/or enclosed at least in sections by the edge, by means of which receiving opening the mobile device can be inserted and/or introduced into the interior of the protective case;
characterized in that the protective case is formed according to at least one of the preceding claim.

8. Mobile system according to claim 7, characterized in that the second edge section, in particular the second edge height, is lowered and/or formed relative to the first edge section in such a way that the mobile device, in particular the display device, is embraced and/or enclosed, in particular protected, circumferentially by the second edge section.

9. Mobile system according to claim 7, characterized in that a transition formed between the mobile device, in particular the display device, and the second edge section is formed at least almost continuously.

10. Mobile system according to claim 7, characterized in that the protective case has a plurality of second edge sections, preferably positioned at different positions along the edge, it being provided that different functions of the mobile device can be triggered or executed by wiping over and/or painting over the respective second edge sections.
